(19) United States
(12) Patent Application Publication
(10) Pub. No.: US 2026/0142200 A1
(43) Pub. Date: May 21, 2026

(54) Coating Structure for Plates, Coating Method for Plates, and Bipolar Plate

(71) Applicant: Robert Bosch GmbH, Stuttgart (DE)

(72) Inventors: Jingjun Zhang, Shanghai (CN); Xinlong Xu, Shanghai (CN)

(21) Appl. No.: 19/390,596

(22) Filed: Nov. 16, 2025

(30) Foreign Application Priority Data
Nov. 18, 2024 (CN) 2024 1164 3773.1

(51) Int. Cl. H01M 8/0228; C25D 13/02; C25D 13/04; C25D 13/12; H01M 8/0258

(52) U.S. Cl. CPC H01M 8/0228; C25D 13/02; C25D 13/04; C25D 13/12; H01M 8/0258

(57) ABSTRACT

A coating structure for a plate is disclosed. The plate includes a first surface oriented toward a membrane electrode MEA structure and a second surface. The first surface includes a protruding ridge and a media channel for directing media, a top of the ridge abutting against the MEA structure and the media channel defined between the ridges. At least a portion of a bottom and a side wall of the media channel relative to an outermost layer of the MEA structure is coated with at least one layer of a first anti-corrosion material and at least the top of the ridge is directly coated with at least one layer of a second anti-corrosion material. The first anti-corrosion material is different from the second anti-corrosion material and the second anti-corrosion material has a higher electrical conductivity than the first anti-corrosion material. Also disclosed is a bipolar plate including the plate as described above and a coating method forming a coating structure as described above. By way of the above, different anti-corrosion materials are employed for the surfaces of the media channels and the surfaces of the ridges of the reaction-active region on the side of the plate facing the MEA structure.

This application claims priority under 35 U.S.C. § 119 to application no. CN 2024 1164 3773.1, filed on Nov. 18, 2024 in China, the disclosure of which is incorporated herein by reference in its entirety.

The present disclosure relates to a coating structure for a plate, and a coating method for a plate. Further, the present disclosure also relates to a bipolar plate comprising a plate as described above.

### BACKGROUND

In the prior art, particularly in the field of fuel cells, such as hydrogen fuel cells, a proton exchange membrane is used as an electrolyte separator. In such a fuel cell, the membrane electrode (MEA, membrane electrode assembly) structure generally comprises three basic components: a cathode, an anode, and an electrolyte membrane, where both the cathode and the anode are composed of a catalyst layer (CL), a microporous layer (MPL), and a gas diffusion layer (GDL). An electrolyte membrane structure is located between the cathode and the anode. For hydrogen fuel cells, the reactants generally include hydrogen fuel (anode) and oxygen (cathode).

The MEA structure is typically sandwiched between a pair of bipolar plates with feature structures such as a channel, an opening, and a sealing on the surface. Its main roles include: conducting electricity, heat, and fluid. The reaction-active region of the bipolar plate is typically composed of alternating media channels and ridges with special geometric shapes, where the media channels serve as pathways for the transport of fluids such as reactants and products. The ridges between adjacent media channels come into direct contact with the GDL of the corresponding electrodes to derive charge generated by electrochemical reactions. The non-reactive region (i.e., excluding the media channel and base) of the bipolar plate includes an inlet that directs fluid into the reaction-active region and dispenses the fluid and an outlet that directs the fluid out of the reaction-active region. Moreover, at an edge of the bipolar plate, there is a sealed structure that prevents the leakage of gas and liquid from the battery.

Common plate materials include graphite and metals, etc. Among them, a metal bipolar plate is lightweight and thin, mechanically strong and easily processed, which is conducive to improved performance and cost reduction of fuel cells. It is important to solve the corrosion problems of metal bipolar plates, especially to improve the corrosion resistance of the surface of bipolar plates facing the MEA structure. This is because corrosion limits the contact conductivity between the bipolar plates and electrodes, affects electrode performance, and accelerates the decomposition of the electrolyte membranes, resulting in attenuation and failure of the fuel cell. In current technology, inorganic materials, such as noble metals (PGM), metal carbon, metal nitrides, and carbon materials, are commonly used as coating materials, and the deposition of coatings is achieved by physical vapor deposition (PVD), which is inefficient and costly.

In the fields of construction, home appliances, automobiles and other consumer and industrial fields, organic coatings are generally used as coating materials. These coatings are applied through spraying, shower coating, roll coating, electrophoresis and other processes, offering good anti-corrosion effects at a low cost. However, as a more stable, less expensive, common anti-corrosion material, organic coatings are rarely used in bipolar plates, mainly due to their poor electrical conductivity.

### SUMMARY

According to a first aspect of the present disclosure, a coating structure for a plate is provided, wherein the plate includes a first surface oriented toward a membrane electrode MEA structure and a second surface opposite the first surface, the first surface including a protruding ridge and a media channel for directing media, a top of the ridge abutting against the MEA structure and the media channel defined between the ridges, all the media channels being integrally molded to form a flow field adapted to ensure distribution of the media over the MEA structure; wherein at least a portion of a side wall and a bottom of the media channel relative to an outermost layer of the MEA structure is coated with at least one layer of a first anti-corrosion material and at least the top of the ridge is directly coated with at least one layer of a second anti-corrosion material, wherein the first anti-corrosion material is different from the second anti-corrosion material and the second anti-corrosion material has a higher electrical conductivity than the first anti-corrosion material.

According to another aspect of the present disclosure, a bipolar plate comprising two plates is provided, wherein at least one of the two plates has a coating structure as previously described, the two plates being disposed such that the two plates abut against each other on their respective second surface sides by way of a bottom of the media channels formed between the respective ridges of the two plates and are fixed to each other by way of an assembly area to form the bipolar plate, wherein the opposing ridges of the bipolar plate define a cooling media channel therebetween on the second surface side.

According to another aspect of the present disclosure, a method for coating a plate is provided, the method comprising: providing a plate comprising a first surface oriented toward an MEA structure and a second surface opposite the first surface, the first surface including a protruding ridge and a media channel for directing media, a top of the ridge abutting the MEA structure and the media channel defined between the ridges; providing a mask at least tightly attached to a top of a ridge to expose at least a portion of a surface of a media channel; submerging the plate covered by the mask into a deposition environment to deposit a first anti-corrosion material on the exposed surface of the media channel; providing another mask that is at least tightly attached to the top of the ridge to expose at least another portion of the surface of the media channel; submerging the plate covered by the other mask into a deposition environment to deposit other anti-corrosion materials on the exposed surface of the media channel; removing the other mask and using at least one further mask to fill and adhere to a surface of the media channel to only expose the top of the ridge on the first surface side; depositing a second anti-corrosion material on the top; removing the at least one further mask; wherein the first anti-corrosion material is different from the second anti-corrosion material and the second anti-corrosion material has a higher electrical conductivity than the first anti-corrosion material.

According to an optional further aspect of the present disclosure, a method for coating a plate is provided, wherein the method comprises: providing a plate comprising a first surface oriented toward an MEA structure and a second surface opposite the first surface, the first surface including a protruding ridge and a media channel for directing media, a top of the ridge abutting the MEA structure and the media channel defined between the ridges; submerging the plate into a deposition environment to deposit a first anti-corrosion material on a first surface of the plate; removing the first anti-corrosion material at a top of the ridge; using a mask to fill and adhere to a surface of the media channel to only expose the top of the ridge on the first surface side; depositing a second anti-corrosion material on the top; removing the mask; wherein the first anti-corrosion material is different from the second anti-corrosion material and the second anti-corrosion material has a higher electrical conductivity than the first anti-corrosion material.

Through the embodiments of the present disclosure, it is possible to, for different regions in the surface of the side of the plate facing the MEA structure, use different anti-corrosion materials for the surfaces of the media channels and the ridges in the reaction-active region on the side of the plate facing the MEA structure, to achieve enhancement or improvement of surface corrosion resistance while ensuring good conductivity between the plate and the MEA structure, in particular improved corrosion resistance of the channel surface, and achieve a cost-effective coating structure of the plate.

### BRIEF DESCRIPTION OF THE DRAWINGS

The above and other advantages of the present disclosure will now be described with reference to the accompanying drawings, which are for illustrative purposes only, wherein

FIG. 1 shows a schematic view of a coating structure for a plate according to an embodiment of the present disclosure;

FIG. 2 shows a schematic view of a bipolar plate according to an embodiment of the present disclosure;

FIG. 3 shows a flow chart of a method for coating a plate according to an embodiment of the present disclosure.

FIG. 4 shows a schematic diagram of a configuration of a plate during various steps of a method for coating a plate according to an embodiment of the present disclosure;

FIG. 5 shows a flow chart of a method for coating a plate according to another embodiment of the present disclosure; and

FIG. 6 shows a schematic diagram of a configuration of a plate during various steps of a method for coating a plate according to another embodiment of the present disclosure.

### DETAILED DESCRIPTION

The following description is merely exemplary in nature and is not intended to limit the present disclosure and the application or use thereof. It will also be understood that in all the drawings, the corresponding reference numerals denote the same or corresponding portions and features. With reference to the disclosed methods, the steps shown are exemplary in nature and therefore are not necessary or critical.

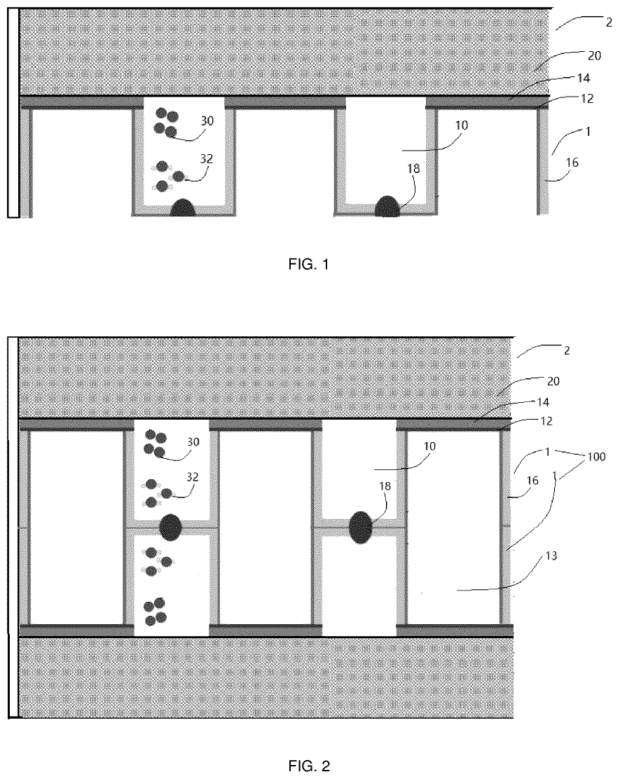

FIG. 1 shows a schematic view of a coating structure for a plate 1 according to an embodiment of the present disclosure, the plate 1 comprising a first surface oriented toward an MEA structure 2 and a second surface opposite the first surface.

As will be known to one skilled in the art, the first surface is configured to distribute a reaction medium or fluid 30 (H2 or O2/air in the case of a fuel cell) over the MEA structure 2 and derive the current generated by an electrochemical reaction within electrodes. The MEA structure 2 includes, for example, porous GDLs 20, such as carbon paper and carbon cloths, which are each set to attach to the outermost two sides of the MEA structure 2 (only porous GDLs on one side are shown in FIG. 1). The first surface of the plate 1 is configured to face a side of the MEA structure 2, particularly a gas diffusion layer on that side, in abutting arrangement.

It is contemplated that the plate 1 is generally formed by any conventional metal sheet molding method, such as compression molding, machining, casting, and photolithography via a photolithographic mask. In a specific embodiment, the plate 1 is formed by compression molding. Further, while the plate 1 is described herein as being made of a metal sheet, it should be understood that the plate 1 may be made of any other suitable electrically conductive material without departing from the scope of the present application, for example, non-metallic materials such as graphite and graphite-filled polymers. Of course, for the plate 1 made of other conductive materials, any possible method compatible with the material can be used for construction, including but not limited to compression molding, machining, casting, or photolithography via a photolithographic mask, 3D printing, and injection molding.

It should be appreciated that the various sizes of metal sheets suitable for use in the plate 1 of the present disclosure are available. In a specific embodiment, the metal sheet has a thickness of approximately 0.002 inches (approximately 0.05 mm) to approximately 0.02 inches (approximately 0.5 mm). However, it will be appreciated that metal sheets of other thicknesses can be used as needed. Suitable metals may include, for example, aluminum and high-quality or low-quality stainless steel. It will also be appreciated that other materials can be used.

In the first surface of the plate 1, the first surface includes a protruding ridge 12 and a media channel 10 for directing media or fluid, wherein a top of the ridge 12 abuts against an MEA structure 2 and the media channel 10 for directing media or fluid is defined between adjacent ridges 12, the media channel 10 being integrally molded to form a flow field adapted to ensure that the media is in contact with the MEA structure 2 (especially its GDL 20) and to ensure the distribution of media on the MEA structure 2. Optionally, the ridge 12 may be formed correspondingly as the media channel 10 is formed such that two sides of each media channel 10 have a respective ridge 12. In the embodiment of FIG. 1, the first surface is configured to face the MEA structure 2, for example, set to face the GDL 20 attached to the MEA structure 2, such that the reaction medium or fluid 30, such as a reaction gas, is distributed along the flow field. The first surface has a plurality of media channels 10 formed therein. The plurality of media channels 10 define a plurality of ridges 12 formed therebetween (or a respective media channel 10 is defined between adjacent ridges 12). The plurality of media channels 10 formed in the first surface form a “flow field” through which a reaction medium flows. For example, the reaction medium can flow from a flow field inlet located at a first end of the plate 1 through the entire flow field (or all media channels 10 in the flow field) or at least one media channel 10 in the flow field to a flow field outlet located at a second end of the plate 1. When the plate 1 is fully assembled to a fuel cell, the ridge 12 is configured to closely contact the MEA structure 2, particularly for example, a gas diffusion layer, to derive the current generated by an electrochemical reaction in the MEA structure 2 to an external circuit. As will be appreciated, the media channel has an unclosed channel shape having a bottom and side walls connected via the bottom. The cross-sectional shape of the media channel may be any suitable shape and is not defined herein. It is contemplated that for cross-sectional shapes such as a V shape, the bottom may be omitted, which is obviously not departing from the scope of the present application.

Generally, the ridge 12 and the media channel 10 are formed on the first surface of the plate 1 described above. For example, the media channel 10 is constructed in the first surface to receive and distribute reaction media from corresponding supply sources. A supply source is connected to an inlet header of a corresponding fuel cell, and the inlet header is connected, for example, to the flow field inlet located at the first end of the plate 1. For example, the media channel 10 is further configured to direct the reacted remaining reaction medium and the reaction product fluid generated by the reaction, such as water, out of the plate 1, e.g., via a corresponding outlet header located on the fuel cell, and the outlet header is connected, for example, to the flow field outlet located at the second end of the plate 1. It should be understood that the first surface of the plate 1 generally corresponds to an active surface of an electrode, and the meaning of the active surface is consistent with conventional understanding by those skilled in the art and is not defined in any additional detail here.

As previously noted, the plates 1 each have a flow field outlet that is respectively connected to an outlet header for reactants and reaction products, such as liquid water and water vapors, to be discharged from the plates 1 or the fuel cell.

In the embodiments of the present application, at least a portion of an outermost layer of the media channel 10 facing the MEA structure 2, i.e., the outermost layer of the side walls and bottom of the media channel relative to the MEA structure, is coated with at least one layer of a first anti-corrosion material 16, and at least a top of the ridge 12 is directly coated with at least one layer of a second anti-corrosion material 14. In the embodiments of the present application, the first anti-corrosion material 16 is optionally different from the second anti-corrosion material 14.

As previously described, the top of the ridge 12 is configured to abut against the MEA structure 2, in particular the porous GDL 20 attached to the MEA structure 2, such that the plate 1 can be configured as a collector plate of the MEA structure 2 to output electrical energy generated by the reaction medium distributed in the media channel 10 of the plate 1 through the MEA structure 2. On this basis, it can be determined that the electrical energy generated by the electrochemical reaction of the reaction medium is conveyed from the MEA structure 2 to the plate 1 and further output. In this case, it is clearly necessary to ensure electrical conductivity between the top of the ridge 12 and the MEA structure 2, in particular the top of the ridge 12 itself.

As known and as previously described, a reaction product 32, such as water, generated via the electrochemical reactions by the reaction medium distributed in the media channel 10 of the plate 1, is also directed and discharged via the media channel 10. These reaction products, such as water, have a certain degree of acidity or alkalinity. For example, in the case of hydrogen fuel cells, the resulting water is somewhat acidic. On the other hand, due to the reaction products themselves and the related electrochemical environment, the first surface of the plate 1, especially the surfaces of the bottom and side walls of the media channel 10 facing the MEA structure 2 (in this case, the layer of the bottom and side walls closest to the MEA structure, as it may come into contact with the media and/or reaction products), is very susceptible to corrosion, which obviously has a negative impact on the durability and performance of the plate 1.

Of course, it is already known in the prior art that a homogeneous anti-corrosion material is applied to the entire first surface of the plate 1 to extend the lifespan of the plate 1. However, for such an embodiment, in the prior art, the homogeneous anti-corrosion material must ensure both electrical conductivity (particularly for the top of the ridge 12) and corrosion resistance. In the prior art, an entire coating of the first surface is typically achieved using inorganic materials, such as noble metal materials, metal carbons, metal nitrides, and carbon materials. However, these materials are expensive on the one hand, and inflexible in coating methods on the other, resulting in significant disadvantages for the plate 1 coated with homogeneous anti-corrosion materials.

To this end, the applicant hereby proposes a new coating structure for the plate 1. Specifically, as previously described, at least a portion of the outermost layer of the bottom and side walls of the media channel 10 relative to the MEA structure 2 (i.e., the outermost layer of the media channel relative to the MEA structure) is coated with at least one layer of the first anti-corrosion material 16, and at least the top of the ridge 12 is directly coated with at least one layer of the second anti-corrosion material 14, wherein the first anti-corrosion material 16 is different from the second anti-corrosion material 14. Specifically, the first anti-corrosion material 16 may be selected from organic anti-corrosion materials that are more cost-effective and more flexible to apply. For example, it can be applied by spraying, shower coating, dip coating, electrophoretic deposition, or any other deposition method (which will be described in detail below). For the second anti-corrosion material 14, to ensure its electrical conductivity, it still employs inorganic materials (especially inorganic conductive materials), such as noble metal materials, metal carbides, metal nitrides, and carbon materials. In fact, the overall idea of achieving application of different coatings to the first surface in sections as described above is: to ensure sufficient conductivity only for the anti-corrosion material on the top of the ridge 12, so that the electrical energy (e.g., current) from the MEA structure 2 can be smoothly concentrated to the plate 1. The conductivity of the anti-corrosion material on the surface of the media channel 10 (which corresponds to the surface of the media channel 10 facing the MEA structure 2, including the side walls and bottom extending downwards from the top of the ridge 12. In other words, the surface of the media channel 10, or the outermost layer of its bottom and side walls relative to the MEA structure (also referred to as the outermost layer), corresponds to the entire surface forming the channel shape of the media channel 10 (obviously excluding the top of the relevant ridge 12)) is not strictly required. In other words, it does not significantly affect the concentration of electrical energy (e.g., current). Thus, it is selectively contemplated that the first anti-corrosion material 16 of the surface of the media channel 10 is selected to be different from the second anti-corrosion material 14 that needs to ensure sufficient electrical conductivity, so as to achieve ease of coating, cost-effectiveness, and durable corrosion resistance.

As previously noted, the electrical conductivity of the second anti-corrosion material 14 is generally higher than that of the first anti-corrosion material 16, making the selection range of the first anti-corrosion material 16 broader, such that the selection range of the first anti-corrosion material 16 includes, for example, organic materials known in the prior art or that can be developed in the future and typically have more superior corrosion resistance. Because the second anti-corrosion material 14 needs to ensure sufficient and excellent electrical conductivity, it is preferably selected from any possible inorganic materials, such as noble metals, metal carbides, metal nitrides, and carbon materials, more specifically, inorganic conductive materials.

Optionally, the first anti-corrosion material 16 has higher corrosion resistance than the second anti-corrosion material 14. As previously noted, this is merely exemplary and non-limiting. Considering that the first anti-corrosion material 16 can focus more on the optimization of the corrosion resistance per se without considering its own conductivity, the first anti-corrosion material 16 is generally selected as a material with the highest possible corrosion resistance, such as an organic material, as described above. In contrast, since the second anti-corrosion material 14 needs to balance both corrosion resistance and conductivity, its selection range is relatively limited, and its own corrosion resistance may be lower than that of the first anti-corrosion material 16 due to the need for a trade-off between corrosion resistance and conductivity. It will be understood that the above description is exemplary only; of course, the first and second anti-corrosion materials 14 having the same corrosion resistance may be employed without departing from the scope of the present application. However, the low-corrosion-resistant first anti-corrosion material 16 may not be able to ensure improved durability of the plate 1 itself due to its own properties.

Of course, in the embodiments of the present application, more than one layer is applied to one side or surface of the bottom and side walls of the media channel 10 relative to the MEA structure 2. That is, in addition to that at least a portion of the outermost layer of the bottom and side walls of the media channel 10 relative to the MEA structure 2 is coated with at least one layer of the first anti-corrosion material 16, the at least a portion is further coated with at least one layer of a third anti-corrosion material (not shown) disposed below the first anti-corrosion material 16. As previously mentioned, since corrosion resistance performance is often guaranteed by the outermost first anti-corrosion material, there are no additional requirements for the various performances of the third anti-corrosion material. However, it is contemplated that the third anti-corrosion material can be selected to help simplify the coating of the coating structure and/or to facilitate adhesion of the first anti-corrosion material 16 or/and provide additional combined functionality. As an example, the third anti-corrosion material may be selected to be the same as the second anti-corrosion material 14, such that the third anti-corrosion material is capable of being deposited while depositing the second anti-corrosion material 14 on the top of the ridge 12, as described later. Of course, the third anti-corrosion material can be selected as being different from the second anti-corrosion material 14, such as providing additional anti-corrosion assurance or providing combined functions such as heat dissipation.

Of course, although only at least one layer of the third anti-corrosion material is described herein, it may be appreciated by those skilled in the art that at least one or more layers of other anti-corrosion materials or non-anti-corrosion materials can be provided below the first anti-corrosion material 16 (as the anti-corrosion capability is directly ensured by the first anti-corrosion material 16) (not shown).

Of course, in the above description of the present application, at least a portion of the outermost layer of the bottom and side walls of the media channel 10 relative to the MEA structure 2 is coated with at least one layer of the first anti-corrosion material 16, and the at least a portion can optionally be the entire outermost layer of the media channel 10 in this orientation. Of course, it is selectively contemplated that only a portion of the outermost layer (instead of the entire outermost layer) of the bottom and side walls of the media channel 10 relative to the MEA structure 2 is coated with at least a layer of the first anti-corrosion material 16. In this instance, the remaining portion of the outermost layer is coated with at least one layer of other anti-corrosion material (not shown) different from the first anti-corrosion material 16, resulting in a regional distribution of the different anti-corrosion materials on the outermost side, and such distribution patterns are clearly not departing from the scope of the present application.

In an embodiment of the present application, optionally, the bottom of the media channel 10 includes an assembly area 18 connected to the bottom of the media channel 10 of another plate 1, and in fact, the two plates 1 in combination with each other form a bipolar plate 1 that will be described in detail later. The outermost surface of a portion of the media channel 10 at least corresponding to the assembly area 18 is coated with at least one layer of a fourth anti-corrosion material (not shown). As will be appreciated by those skilled in the art and as will be described in detail later, the assembly area 18, especially the assembly area 18 assembled with another plate 1 via welding or any other suitable manner, is typically more susceptible to corrosion such as pitting corrosion and galvanic corrosion (due to the application of welding materials) because of the manner in which it was assembled. In this case, it is necessary to provide additional protection to these assembly areas 18. Accordingly, it is necessary to ensure that an anti-corrosion material is applied to the corresponding regions of the above-mentioned outermost layer of the assembly area 18 to prevent corrosion of the regions from reaction products, for example.

As will be understood, the fourth anti-corrosion material may be the same as or different from the first anti-corrosion material 16. In the same case, the fourth anti-corrosion material may be formed simultaneously with the first anti-corrosion material 16 on the outermost layer of the media channel 10 such that the outermost side of the media channel 10 towards the MEA structure 2 forms a materially uniform outermost layer. Of course, it is considerable to apply an anti-corrosion material with additional properties to the corresponding outermost layer of the assembly area 18 to enhance additional protection to the location. For example, the fourth anti-corrosion material may be applied to the outermost layer at a location corresponding to the assembly area 18 to form a corresponding protection area. Optionally, the corrosion resistance of the fourth anti-corrosion material is higher or equal to that of the first anti-corrosion material 16.

Further, it is to be understood that since both the first anti-corrosion material 16 and the fourth anti-corrosion material are the outermost anti-corrosion materials, similar to the first anti-corrosion material 16, one or more layers of other anti-corrosion materials may also be present below the fourth anti-corrosion material.

Further, especially for hydrogen fuel cells, the reaction product fluid such as water directed in the media channel 10 typically exhibits a certain degree of acidity. Therefore, in order to ensure the protection of the plate 1, the first anti-corrosion material 16 is generally resistant to acid corrosion. However, this is not to be limiting, and any first anti-corrosion material 16 adapted to the environment in which it is located may be selected without departing from the scope of the present application. Further, it is to be noted that although not specifically mentioned herein, it is clear that various other anti-corrosion materials, such as the second, third, and fourth anti-corrosion materials, may be selected advantageously to adapt to the acidity and alkalinity of the environment in which they are located and do not deviate from the scope of the present application. Of course, acid and alkali resistance is only one aspect of corrosion resistance, and different anti-corrosion materials may be selected correspondingly considering the different corrosion characteristics of different fuel cells without departing from the scope of the present application.

Although description is made above with respect to the coating structure of the plate 1, it should be understood by those skilled in the art that the coating structure described above is merely exemplary and not restrictive. Variations can be made on the basis of the above disclosure without departing from the scope of the present application. For example, the thickness of the first or fourth anti-corrosion material may be the same as or different from the thickness of the second or third anti-corrosion material. For another example, the thickness of the layers formed by the various corrosion materials can remain uniform and constant or can be selectively formed to have different thicknesses in different regions.

FIG. 2 illustrates a schematic view of a bipolar plate 1 according to an embodiment of the present disclosure. As shown in FIG. 2, the bipolar plate 1 is actually formed by assembling two plates 1 on a side opposite the MEA structure 2 (e.g., such that outer portions of the bottoms of the respective media channels 10 of the two plates 1 are aligned with each other and assembled). For example, on a second surface side of the plate 1, the bottoms of the media channels 10 formed between the corresponding ridges 12 of the two plates 1 are brought into contact with and abut against each other and secured to each other by way of the assembly area 18 to form the bipolar plate 1. In the schematic diagram of FIG. 2 of the present application, the composition of the plate 1 as described above may be employed. However, it is to be noted that the coating structure of the two plates 1 may be the same or different, provided that at least one of the plates 1 is a plate 1 that conforms to the features described above. By way of example, the two plates 1 may be identical; both plates 1 have similar coating structures consistent with the features described above, e.g., the respective first anti-corrosion material 16 may be selected differently as a result of being used to direct different media and/or reaction products; only one of the two plates 1 has a coating structure consistent with the features described above and the other plate 1 does not have the coating structure described above. Of course, those skilled in the art should understand that these are all selectable.

In the embodiment of FIG. 2, a cooling media channel 13 is preferably shown, and the cooling media channel is defined between the oppositely disposed ridges 12 of the two plates 1 on the second surface side.

Further, FIG. 2 shows the plate 1 being joined together by welding at the assembly area 18, for example, to form the assembled bipolar plate 1. As is well known in the art, bonding can be achieved by brazing, diffusion bonding, laser welding, adhesive bonding, or gluing with a conductive adhesive, which are thus optional as well.

It will be understood that the cooling media channel 13 also has cooling media channel inlet and outlet, which is optionally be supplied counter-currently, in a direction opposite to the reaction media flow direction, or supplied in the same direction as the reaction media flow, or supplied in any other manner without departing from the scope of the present application.

The following will describe in detail how the above-described coating structure is implemented on a molded plate 1 to achieve a distribution of at least two anti-corrosion materials applied per area.

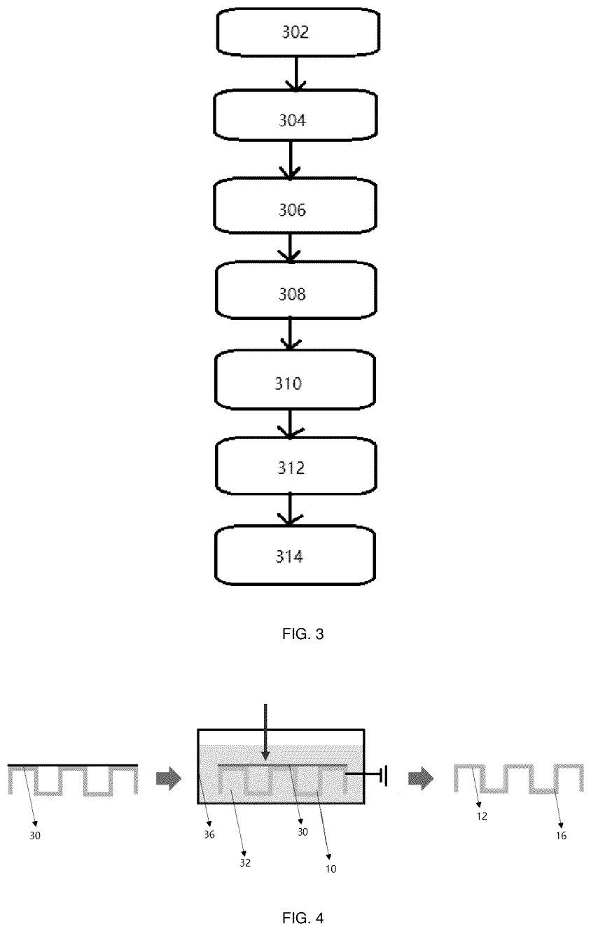

FIG. 3 shows a flow chart of a method for coating a plate 1 according to an embodiment of the present disclosure, and FIG. 4 shows a schematic diagram of a configuration of the plate 1 during various steps of the method for coating the plate 1 according to an embodiment of the present disclosure. It is to be noted that, in the following embodiments of the present application, an embodiment of applying the same coating structure to the surface or the outermost layer of the media channel 10 is described; however, this is only exemplary and not limiting.

In the embodiment of FIG. 3, at step 300, a molded plate 1 is provided. The plate 1 is a plate 1 as described above, e.g., a plate 1 including a first surface oriented toward the MEA structure 2 and a second surface opposite the first surface, the first surface including a protruding ridge 12 and a media channel 10 for directing media, a top of the ridge 12 abutting the MEA structure 2, in particular a porous GDL 20 attached to the MEA structure 2, and the media channel 10 being defined between the ridges 12.

At step 302, a first mask 30 that is tightly attached to the top of the ridge 12 is provided, and optionally, a second mask (not shown) tightly attached to at least a first portion of the surface or the outermost layer (referred to as the outermost layer hereinafter) of the bottom and side walls of the media channel 10 relative to the MEA structure is also provided to expose at least a second portion of the surface or the outermost layer of the media channel 10 or to allow at least the second portion of the media channel 10 to remain clear. At this step, it is to be emphasized that the first mask covers all areas of the top of the ridge 12 that need to abut the MEA structure 2 so that these regions are not interfered with by subsequent application of undesirable material coating. The second mask is also configured to prevent the material being applied from interfering with at least the first portion where it is not desired to be applied. As noted above, at least the second portion of the media channel 10 is kept clear, in particular exposing the outermost layer of at least a portion of the side of the media channel 10 toward the MEA structure or exposing the respective area of the surface of the media channel 10 requiring application of an anti-corrosion material to be applied such that the respective anti-corrosion material to be applied is accessible and can be deposited to the respective area, for example. It will be understood that, for the plate 1, the second surface of the plate is always masked as it may not need deposition of additional material. Although this step is not described in the specific embodiments, it does not deviate from the scope of protection of the present application.

At step 304, the first mask 30 is covered, and optionally the plate 1 covered by the second mask is submerged into a deposition environment 32, such as an electrophoretic fluid in an electrophoretic cassette 36, to deposit, such as electrophoretic deposition, the first anti-corrosion material 16 on at least the exposed second portion of the surface or the outermost layer of the media channel 10. Although electrophoretic deposition is described herein, it should be understood by those skilled in the art that other deposition methods are also optional, such as vacuum deposition and vapor deposition. However, in the present technical solution, the use of an electrophoretic fluid allows for a simpler structure of the first mask and more even deposition, and thus the electrophoretic deposition is clearly the most preferred in the embodiments of the present application. With respect to construction simplification of the first mask, and optionally the second mask, it should be understood that, as a result of the use of electrophoretic fluid, the shapes are not limited as long as the first mask is capable of covering the top of the ridge 12, and optionally the second mask is capable of covering at least the first portion of the media channel 10. As a simplest example, the first mask is configured as an integral plate with a pattern that is capable of closely matching the top of the ridge 12. Optionally, the second mask is also configured as an integral plate with a pattern that is capable of closely matching at least the first portion of the media channel 10. Optionally, the first and second masks are capable of cooperating with each other without interfering with each other as they cover the respective areas of the plate 1 to ensure coverage to the desired areas. Optionally, the first mask and the second mask are configured as an integral mask. The above patterns may be achieved in any possible way, such as stamping and etching. Obviously, the manufacturing of such a first mask or second mask is simple and cost-effective.

Optionally, at step 306, only the second mask is removed (i.e., the first mask is not removed) and a third mask (not shown) that is tightly attached to at least the second portion of the surface of the media channel 10 is provided to expose at least the first portion of the surface of the media channel 10, i.e., the outermost layer of the bottom and side walls of the media channel relative to the MEA structure. As an example, the structure and properties of the third mask are similar to or identical to those of the second mask.

Optionally, at step 308, the plate 1 covered by the first mask and the third mask is submerged into a deposition environment, such as another electrophoretic fluid in the electrophoresis cassette 36, to deposit other anti-corrosion materials on at least the exposed second portion of the surface or the outermost layer of the media channel 10, such as electrophoretic deposition.

Optionally, at step 310, the first mask and the optional second or third mask are removed, and the fourth mask 34 is used to cover and adhere to the surface or the outermost layer of the media channel 10 to only expose the top of the ridge 12 on the first surface side or the portion to abut against and contact the MEA structure 2 or to expose the portion that is covered in both the step 302 and the optional step 306. Optionally, the fourth mask 34 may be selectively assembled from the second and third masks. In this instance, a deposition operation of another anti-corrosion material may be performed on a corresponding top.

Optionally, at step 312, the second anti-corrosion material 14 is deposited on a top or on an exposed area. It will be understood that this deposition process can be performed using a process that is different from the electrophoretic deposition for the second anti-corrosion material 14 or also using the electrophoretic deposition process, and all these are not departing from the scope of the present application.

At step 314, the fourth mask 34 is removed, completing the application or coating of the coating structural plate for partitioned sections of the polar plate 1.

As previously noted, in the solution of the present application, the first anti-corrosion material 16 is different from the second anti-corrosion material 14 and the second anti-corrosion material 14 has a higher electrical conductivity than that of the first anti-corrosion material 16. The reason for the selection of specific anti-corrosion materials has been previously described and is not further described herein. Of course, optionally, the first anti-corrosion material 16 is different from the second anti-corrosion material 14 and other anti-corrosion materials; and the second anti-corrosion material 14 has a higher electrical conductivity than that of the first anti-corrosion material 16 and/or other anti-corrosion materials. The reason for the selection of specific anti-corrosion materials has been previously described and is not further described herein.

It is to be emphasized that, although not expressly stated in the above technical solution, the above method also includes a step of cleaning the area covered by the mask after the mask is removed to ensure the removal of the mask material. Further, although not explicitly stated in the above technical solution, the above method also includes a step of polishing the deposited areas after deposition of the first, second, or other anti-corrosion materials to ensure surface properties of the first, second, or other anti-corrosion materials, such as removing unevenness and reducing defects such as surface pores. As noted above, optionally, it is also within the scope of the present application to use a suitable mask or a combination of masks to cover certain areas of the plate 1, so as to expose only the areas to be coated with the corresponding anti-corrosion material and then to use a suitable deposition method to achieve application of the corresponding anti-corrosion material. The implementation process of the anti-corrosion materials in these other areas is similar to the process of applying the first, second, or other anti-corrosion materials, and is not further described here.

FIG. 4 illustrates a schematic diagram of a configuration of the plate 1 during various steps of applying the first anti-corrosion material 16 by electrophoretic deposition to the surface or the outermost layer of the media channel 10 of the side of the plate 1 facing the MEA structure 2 as shown in the flowchart shown in FIG. 3, with specific illustrations of how to achieve the application process of the first anti-corrosion material 16 and respective configurations of the related components and the plate 1 involved in the process.

In the embodiment of FIG. 4, only the use of the first mask 30 is shown, but it is contemplated that the related implementation steps of other different masks are generally similar and are not further described here. In FIG. 4, the following are shown in turn: providing the molded plate 1 and providing the first mask tightly attached to the top of the ridge 12; depositing the first anti-corrosion material 16 on the surface of the media channel 10; and removing the first mask 30.

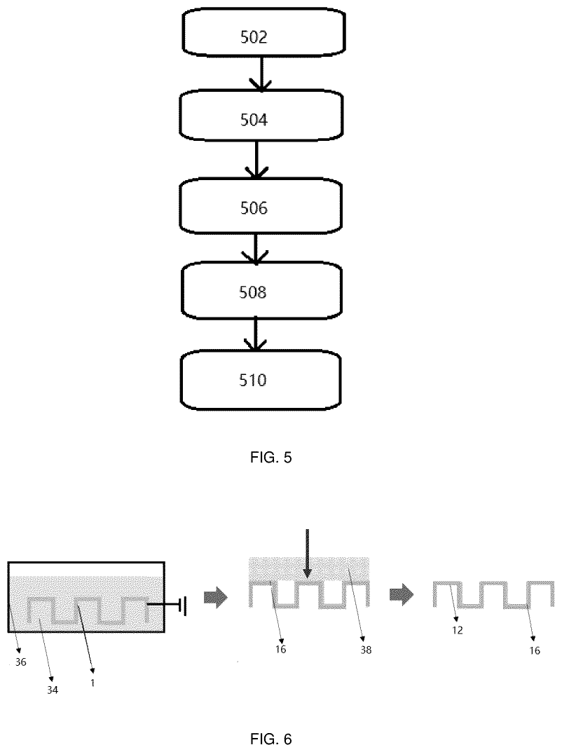

FIG. 5 shows a flow chart of a method for coating the plate 1 according to another embodiment of the present disclosure, and FIG. 6 shows a schematic diagram of a configuration of the plate 1 during various steps of a method for coating the plate 1 according to another embodiment of the present disclosure.

In the embodiment of FIG. 5, at step 500, a molded plate 1 is provided. The plate 1 is a plate 1 as described above, e.g., a plate 1 including a first surface oriented toward the MEA structure 2 and a second surface opposite the first surface, the first surface including a protrudingly formed ridge 12 and a media channel 10 for directing media, a top of the ridge 12 abutting against the MEA structure 2 and the media channel 10 defined between the ridges 12.

At step 502, the plate 1 is submerged into a deposited environment, such as electrophoretic fluid, to deposit, such as electrophoretic deposition, the first anti-corrosion material 16 on a surface area of the side of the plate 1 facing the MEA structure 2. Although electrophoretic deposition is described herein, it should be understood by those skilled in the art that other deposition methods are also optional, such as vacuum deposition and vapor deposition. However, in the present technical solution, the use of an electrophoretic fluid allows for a simpler structure of the first mask and more even deposition, and thus the electrophoretic deposition is clearly the most preferred in the embodiments of the present application.

At step 504, the first anti-corrosion material 16 on the top or at a location on the top of the ridge 12 to abut against and contact the MEA structure 2 is removed, for example, by a removal tool 38. As those skilled in the art will appreciate, the removal may take any appropriate manner without departing from the scope of the present application, such as by polishing, cutting, and/or using another physical removal device and/or chemical, optical, acoustic removal manners. It is to be emphasized that the selected removal means should be as fine as possible to precisely remove the portion of the first anti-corrosion material 16 desired to be removed.

Optionally, at step 506, a fourth mask 34 is used to tightly attach to the surface or the outermost layer of the media channel 10 after removing the first anti-corrosion material 16 on the top to only expose the top of the ridge 12 or the portion to abut against and contact the MEA structure 2 on the first surface side. In this instance, a deposition operation of another anti-corrosion material may be performed on a corresponding portion.

Optionally, at step 508, the second anti-corrosion material 14 is deposited on a top or on an exposed area. It will be understood that this deposition process can be performed using a process that is different from the electrophoretic deposition for the second anti-corrosion material 14 or also using the electrophoretic deposition process, and all these are not departing from the scope of the present application.

Optionally, at step 510, the second mask is removed, completing the application of the coating structural plate for partitioned sections of the polar plate 1.

It is to be noted that where different anti-corrosion materials are deposited on the surface or different portions of the outermost layer of the media channel 10, these different portions may be optionally included in order first and corresponding anti-corrosion materials may be deposited, so multiple layers of corresponding anti-corrosion materials can be deposited on the top. Therefore, during removal, the step 506 is adapted to remove the anti-corrosion material from the top (not only the first anti-corrosion material 16) instead of removing the first anti-corrosion material 16. At least the entire surface of the media channel 10 is then covered with a mask.

As previously noted, in the solution of the present application, the first anti-corrosion material 16 is different from the second anti-corrosion material 14 and the second anti-corrosion material 14 has a higher electrical conductivity than that of the first anti-corrosion material 16. The reason for the selection of specific anti-corrosion materials has been previously described and is not further described herein.

It is to be emphasized that, although not expressly stated in the above technical solution, the above method also includes a step of cleaning the area covered by the mask after the second mask is removed to ensure the removal of the mask material. Further, although not explicitly stated in the above technical solution, the above method also includes a step of polishing the deposited areas after deposition of the first or second anti-corrosion material 14 to ensure surface properties of the first or second anti-corrosion material 14, such as removing unevenness and reducing defects such as surface pores. In addition, although not explicitly stated in the above technical solution, the above method also includes applying anti-corrosion materials other than the first and second anti-corrosion material 14. For this step, the corresponding mask is optionally used to mask a certain area of the plate 1 so that only the area to be coated with the other anti-corrosion materials is exposed and the application of corresponding anti-corrosion materials is then achieved by appropriate deposition. The implementation process of the other anti-corrosion materials in these other areas is similar to the process of applying the first and second anti-corrosion materials 14, and is not further described here.

Moreover, it is to be understood that although in the above embodiments of FIGS. 3 and 5, the implementation of the second anti-corrosion material 14 for the top is achieved by the use of the second mask, this is merely illustrative and any other available method that enables the local deposition of the anti-corrosion material for a respective portion may be employed to achieve the above described process without departing from the scope of the present application.

FIG. 6 shows a schematic diagram of a configuration of the plate 1 during various steps of applying the first anti-corrosion material 16 by electrophoretic deposition on the surface or the outermost layer of the media channel 10 of the side of the plate 1 facing the MEA structure 2 as shown in the flowchart shown in FIG. 5, with specific illustrations of how to achieve the application process of the first anti-corrosion material 16 and respective configurations of the related components and the plate 1 involved in the process.

In the embodiment of FIG. 6, the following are shown in turn: providing the molded plate 1 and depositing the first anti-corrosion material 16 on the entire first surface or the entire area of the first surface including a media channel and a ridge, and removing the first anti-corrosion material 16 from the top of the ridge 12 by the removal tool 38.

It is also contemplated to first deposit the second anti-corrosion material 14 on the entire first surface or the entire area of the first surface including a media channel and a ridge, then deposit the first anti-corrosion material 16 on the entire first surface or the entire area of the first surface including a media channel and a ridge, and remove the first anti-corrosion material 16 located on the top or at a location on the top of the ridge 12 to abut against and contact the MEA structure 2, e.g., by the removal tool 38, to expose the second anti-corrosion material 14. Obviously, such an approach is also included in the embodiments of the present application without departing from the scope of the present application.

It will be appreciated that the constructions and/or methods described herein are exemplary in nature and that since many variants are possible, these particular embodiments or typical examples should not be considered to have a limiting meaning. A particular routine or method described herein may represent one or a plurality of any number of handling strategies. As such, the various actions shown and/or described may be performed in the order shown and/or described, in other orders, in parallel, or omitted. Likewise, the order of the methods described above may be changed. Although the deposition methods of different anti-corrosion materials of the present application are described in different embodiments among the embodiments of the present application, it should be understood by those skilled in the art that these embodiments may be combined or supplemented with one another without departing from the scope of the present application.

Although the examples of the present application are described above with reference to the accompanying drawings, those skilled in the art are capable of making various modifications or substitutions to the above examples in accordance with the teachings of the present application without departing from the scope of the present application.

What is claimed is:

1. A coating structure for a plate, wherein the plate includes a first surface oriented toward a membrane electrode MEA structure and a second surface opposite the first surface, the first surface including a protruding ridge and a media channel for directing media, a top of the ridge abutting against the MEA structure and the media channel defined between the ridges, all the media channels being integrally molded to form a flow field adapted to ensure distribution of the media over the MEA structure; wherein at least a portion of a side wall and a bottom of the media channel relative to an outermost layer of the MEA structure is coated with at least one layer of a first anti-corrosion material and at least the top of the ridge is directly coated with at least one layer of a second anti-corrosion material, and wherein the first anti-corrosion material is different from the second anti-corrosion material and the second anti-corrosion material has a higher electrical conductivity than the first anti-corrosion material.

2. The coating structure according to claim 1, wherein the first anti-corrosion material has higher corrosion resistance than the second anti-corrosion material.

3. The coating structure according to claim 1, wherein the first anti-corrosion material is selected as an organic material and the second anti-corrosion material is selected as an inorganic conductive material.

4. The coating structure according to claim 3, wherein the second anti-corrosion material is selected from the group consisting of at least a noble metal material, a metal carbide, a metal nitride, and a carbon material.

5. The coating structure according to claim 1, wherein a side of the media channel facing the MEA structure is coated with a third anti-corrosion material disposed below the first anti-corrosion material, and wherein the third anti-corrosion material is the same as or different from the second anti-corrosion material.

6. The coating structure according to claim 1, wherein the bottom of the media channel comprises an assembly area connecting to a media channel of another polar plate, and an outermost side of a portion of the media channel corresponding to at least the assembly area is coated with at least one layer of a fourth anti-corrosion material, the fourth anti-corrosion material being the same as or different from the first anti-corrosion material.

7. The coating structure according to claim 3, wherein the first anti-corrosion material is selected from organic materials resistant to acidic corrosion.

8. A bipolar plate comprising two plates, wherein at least one of the two plates has a coating structure according to claim 1, the two plates being disposed such that the two plates abut against each other on their respective second surface sides by way of a bottom of the media channels formed between the respective ridges of the two plates and are fixed to each other by way of an assembly area to form the bipolar plate, and wherein the opposing ridges of the bipolar plate define a cooling media channel therebetween on the second surface side.

9. A method for coating a plate, comprising:
providing a plate comprising a first surface oriented toward an MEA structure and a second surface opposite the first surface, the first surface including a protruding ridge and a media channel for directing media, a top of the ridge abutting the MEA structure and the media channel defined between the ridges;
providing a mask at least tightly attached to a top of a ridge to expose at least a portion of a surface of a media channel;
submerging the plate covered by the mask into a deposition environment to deposit a first anti-corrosion material on the exposed surface of the media channel;
providing another mask that is at least tightly attached to the top of the ridge to expose at least another portion of the surface of the media channel;
submerging the plate covered by the other mask into a deposition environment to deposit other anti-corrosion materials on the exposed surface of the media channel;
removing the other mask and using at least one further mask to fill and adhere to a surface of the media channel to only expose the top of the ridge on the first surface side;
depositing a second anti-corrosion material on the top; and
removing the at least one further mask,
wherein the first anti-corrosion material is different from the second anti-corrosion material and the second anti-corrosion material has a higher electrical conductivity than the first anti-corrosion material.

10. A method for coating a plate, comprising:
providing a plate comprising a first surface oriented toward an MEA structure and a second surface opposite the first surface, the first surface including a protruding ridge and a media channel for directing media, a top of the ridge abutting the MEA structure and the media channel defined between the ridges;
submerging the plate into a deposition environment to deposit a first anti-corrosion material on a first surface of the plate;
removing the first anti-corrosion material at a top of the ridge;
using a mask to fill and adhere to a surface of the media channel to only expose the top of the ridge on the first surface side;
depositing a second anti-corrosion material on the top; and
removing the mask,
wherein the first anti-corrosion material is different from the second anti-corrosion material and the second anti-corrosion material has a higher electrical conductivity than the first anti-corrosion material.
